(19) United States
(12) Patent Application Publication
(10) Pub. No.: US 2007/0186466 A1
(43) Pub. Date: Aug. 16, 2007

(54) Plant protective cover system with collapsible rigid frame

(76) Inventor: Christopher Benjamin Gardiner, Alexandria, VA (US)

Correspondence Address: CHRISTOPHER BENJAMIN GARDINER, 6726 SWARTHMORE DRIVE, ALEXANDRIA, VA, 22307, US

(21) Appl. No.: 11/698,916

(22) Filed: Jan. 29, 2007

Related U.S. Application Data
(60) Provisional application No. 60/762,537, filed on Jan. 27, 2006.

(51) Int. Cl. A01G 13/02

(52) U.S. Cl. 47/29.5; 47/29.6

(57) ABSTRACT

The present teachings provide, among other things, methods, systems, apparatus, and devices for providing protection for outdoor plants against the elements, and for regulation of climactic conditions for both indoor and outdoor plants. The present teachings provide, for example, methods and apparatus for covering growing plants to protect them from the elements, and to a freestanding rigid but collapsible frame and a fitted protective cover for use, for example, in cultivated agricultural fields, farmlands, and indoor spaces.

### CROSS-REFERENCE TO RELATED APPLICATIONS

This application claims a priority benefit under 35 U.S.C. § 119(e) from U.S. Provisional Patent Application No. 60/762,537, filed Jan. 27, 2006, which is incorporated herein by reference.

### FIELD

The present teachings relate to methods, systems, apparatus, and devices for providing protection for outdoor plants against the elements, and for regulation of climactic conditions for both indoor and outdoor plants.

### INTRODUCTION AND BACKGROUND

Various items have been used to protect plants during their initial stages of growth in the early spring, or from harsh temperatures and frost in the autumn. Seedlings, bulbs, and shoots are generally started in a greenhouse. Their growing environment may therein be controlled and they are protected from the elements until they reach a size to withstand the weather of early spring or the risk of adverse weather has passed, although this adds considerably to the end cost of the plant, produce, fruit, or blossoms. Plants which are particularly vulnerable to the elements—such as rose bushes or tomatoes—may often be covered with straw, burlap, or leaves in anticipation of frost or snow. Smudge pots are used in the fall to heat orchards where the trees are too large to be covered.

Indoor plants can also suffer dramatically from decreased levels of humidity during the dryer seasons of fall and winter. Styrofoam containers ranging from cup to bushel-basket size may be used as plant protectors. Small plants may also be covered with overturned potting containers, baskets, or commercially produced plant covers. Such items tend to be relatively expensive when compared to the end price which may be obtained for the plant or its produce, and it is therefore necessary that the cost of the plant protector be spread over a useful life of many growing seasons, and not add in other ways to the costs of raising those plants. One product which has been primarily marketed to home gardeners under the trademark “Hot Caps” consists of a dome-like structure molded out of a material similar to wax impregnated paperboard. While inexpensive, this product is still degraded by the elements, and will generally withstand use for only a single season. It is difficult to anchor this product to the ground so that it will not be blown away. Furthermore, this product does not provide any ventilation for the growing plant. Although a user could cut the top off the dome or puncture holes in the side, such measures would prevent the structure from later providing the needed protection for the plant, and present a problem when the plants eventually mature and grow through those holes, then becoming too large to remove. The other available alternative is to set out and retrieve each hot cap daily, a process both impractical and expensive when dealing with a large expanse of agricultural field containing many thousands of plants. Another device has been shown and described in U.S. Pat. No. 4,267,655 entitled “Double Walled Thermal Protective Coverings.” One embodiment of this device has been marketed under the trademark “Wall-O-Water,” and is intended for use primarily in the spring to accelerate the normal planting and growing season. This device comprises a plurality of tubes manufactured from a thin, flexible plastic sheeting and fastened together longitudinally. Because the plastic is very thin, rigidity is imparted to the structure by filling each individual tube with water. The tubes may be oriented in either a vertical or horizontal configuration to form side walls of a cylinder or truncated cone which surround the growing plant. Although this device has proven effective for lengthening the early growing season, as well as accumulating and utilizing solar energy, it does present several drawbacks. Filling each tube with water is a time consuming and tedious process which requires a great deal of stooping or bending over. A water tank having the appropriate nozzle must be driven through the field, and the individual setting up the plant protectors must walk through the field or dismount the vehicle repeatedly. It is difficult to set up the device and fill the individual tubes because they tend to collapse unless supported by some preexisting frame or structure, and the device may thereby damage delicate plants if handled improperly. Filling each tube alternately with increasing amounts of water to prevent such a collapse proves to be an even more time consuming process. Because the tubes must be individually filled with water and later emptied, and the water is expected to freeze and expand, no provision is made for the tubes to be completely sealed, and enough water may evaporate from the tubes over a short period so as to weaken the structure. The only embodiment of the device which permits both ventilation and protection incorporates a drawstring threaded through loops at the top of the tubes. To use this drawstring, however, the tubes must be only partially filled with water. This eliminates any structural integrity which would otherwise hold the top of the cylinder open, and the tubes are free to fold over and close off the opening, thereby preventing any ventilation. Other embodiments of the device prevent ventilation or sunshine from reaching the plant, do not serve to protect the plant from heavy rains, hail, or wind, and require separate internal structures to protect the plant from being crushed by the water filled tubes themselves. While the tubular plant protector permits an enclosed volume as much as four times greater than the hot caps, and indeed requires such a larger volume to permit the extended growth period which it may ostensibly provide, all the embodiments of the water filled tube design have a limiting maximum size or height above which the structure will crimp and collapse from its own weight. A water filled plant protector also presents some unique disadvantages in the autumn, when the water increases the likelihood of frost subliming on the leaves of the plant, and retains the nighttime cold when there is no morning sunshine the subsequent day. Additionally, the water which remains trapped in each tube after being emptied keeps the devices from being stored away without drying, itself a difficult process, or leads to mold or mildew if stored improperly. Although the plastic tubes do permit a longer useful life than the previously mentioned hot caps, they are still only expected to survive a few years of use if they are handled with the utmost of care, and not exposed to the many sharp objects one normally encounters in the field. An inadvertent scrape or blow to the water filled tubes will cause them to tear, and may result in the entire structure collapsing onto the plant. If a protector is damaged, a new protector must be obtained and filled, or a supply of extra protectors and a watering can must be carried each time one goes into the field.

Background Art:

U.S. Pat. No. 195,913 October, 1877 Antisdale

U.S. Pat. No. 303,543 August, 1884 Prentiss

U.S. Pat. No. 757,045 April, 1904 Lane

U.S. Pat. No. 1,485,924 March, 1924 Hobbs

U.S. Pat. No. 1,848,345 March, 1932 Gregg

U.S. Pat. No. 1,916,868 July, 1933 Starks

U.S. Pat. No. 2,063,822 December, 1936 Muller

U.S. Pat. No. 2,191,808 February, 1940 Schramm

U.S. Pat. No. 2,226,812 December, 1940 Goldberg

U.S. Pat. No. 2,626,483 January, 1953 Service

U.S. Pat. No. 2,665,523 January, 1954 Hardman

U.S. Pat. No. 2,725,675 December, 1955 Odle

U.S. Pat. No. 2,753,662 July, 1956 Behnke

U.S. Pat. No. 2,820,468 January, 1958 Park et al.

U.S. Pat. No. 2,832,178 April, 1958 Arthurs

U.S. Pat. No. 2,889,664 June, 1959 Olshansky

U.S. Pat. No. 3,384,992 July, 1964 Heffron

U.S. Pat. No. 4,821,453 April, 1989 Moorehead

U.S. Pat. No. 5,509,229 April, 1996 Thomasson et al.

U.S. Pat. No. 5,970,653 October, 1999 Liang et al.

### SUMMARY

Various embodiments of the present teachings provide, among other things, a plant protector system which provides structural rigidity and is self-supporting, to protect the enclosed plant from the elements, and to permit easy and quick erection without the addition of other materials, or the use of tools.

In various embodiments, the plant protective cover system can comprise a collapsible rigid frame such that it can be constructed through the use of sufficiently rigid and strong and flexible material such as coiled aluminum or plastic or fiberglass, or other such materials, and then stored in a minimum of space with little effort.

In various embodiments, the plant protective cover system can comprise a collapsible rigid frame so that it can be easily and inexpensively manufactured and assembled, provide extended re-use, and be easily repaired.

In various embodiments, the plant protective cover system with collapsible rigid frame can be adapted to transmit substantial amounts of light to the growing plant, and yet serve to insulate the plant from the cold without overheating the plant during warm days.

In various embodiments, the plant protective cover system with collapsible rigid frame can be adapted to be simply anchored to the ground.

In various embodiments, the plant protective cover system with collapsible rigid frame can be manufactured in a wide variety of sizes without diminishing the structural integrity of the plant protective cover system with collapsible rigid frame, and can be manufactured in sizes sufficient to protect different types of plants or several plants at one time.

In various embodiments, the plant protective cover system with collapsible rigid frame can be configured such that the user can alter the overall size of the plant protective cover system with collapsible rigid frame.

These and other features and advantages of various embodiments of the present teachings will be readily understood by those skilled in the art as the following description is read in conjunction with the accompanying drawings, wherein like reference numerals have been used to refer to like elements throughout the several views.

### BRIEF DESCRIPTION OF FIGURES

FIG. 1 is a perspective view of a system in the upright, assembled position with the fitted polyethylene cover pulled approximately 80% down exposing details of the interlocking circular base ring and demonstrating the opaque and transparent areas of the fitted polyethylene cover, according to various embodiments.

FIG. 2 is a perspective view of the assembled rigid frame, according to various embodiments.

FIG. 3 is a perspective view of the un-locked interlocking circular base ring, according to various embodiments.

FIG. 4 is a perspective boxed-view of the apex of the assembled interconnected ribs showing the central interlocking point at which the locking pin is inserted as well as to where the ribs overlap at their respective center points, according to various embodiments.

FIG. 5 is the perspective cutaway-view of both the locking tab with a convex dimpled tongue end and the slot and lock area of the interlocking circular base ring ends, according to various embodiments.

FIG. 6 is a perspective cutaway-view of an individual rib end with its convex dimple detail and its corresponding interlocking circular base ring attachment slot and lock area, according to various embodiments.

FIG. 7 is a perspective view of a system in an outdoor setting demonstrating how the system may be anchored to the earth by means of soil or rock covering the lower and extended portion of the fitted polyethylene cover which is indicated by the bottom-most broken line at the drawings base, according to various embodiments.

FIG. 8 is a one-dimensional view of the north or south facing opaque side of the fitted polyethylene cover showing the approximate locations of the top and internal seams and the approximate location of the vent opening, according to various embodiments.

FIG. 9 is a one-dimensional view showing the approximate top seam and vent opening locations as viewed from the perspective of the bottom of the fitted polyethylene cover, according to various embodiments.

FIG. 10 is a one-dimensional view of the east or west facing transparent side of the fitted polyethylene cover showing the shape of the cover from that perspective, according to various embodiments.

### DESCRIPTION OF VARIOUS EMBODIMENTS

Reference will now be made to various embodiments, examples of which are illustrated in the accompanying drawings.

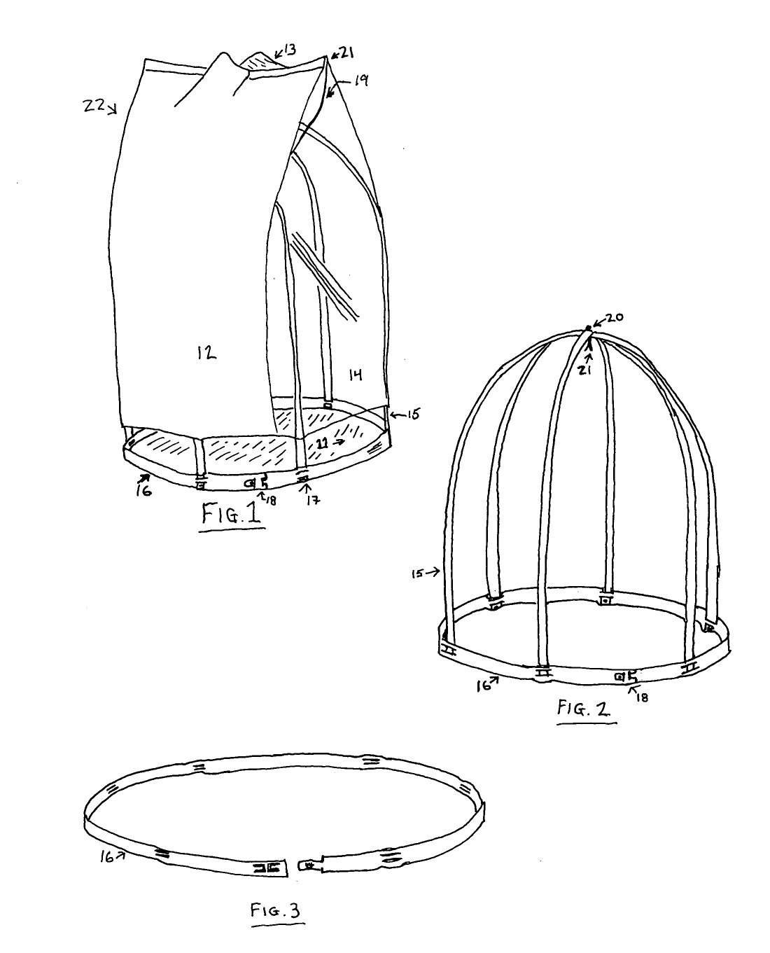

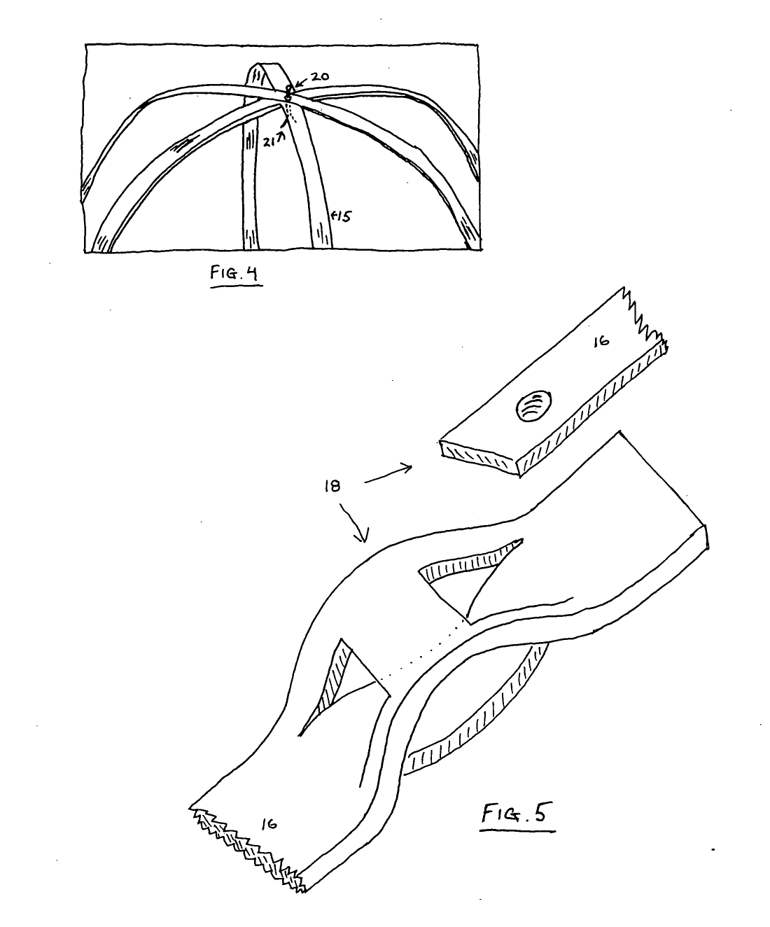

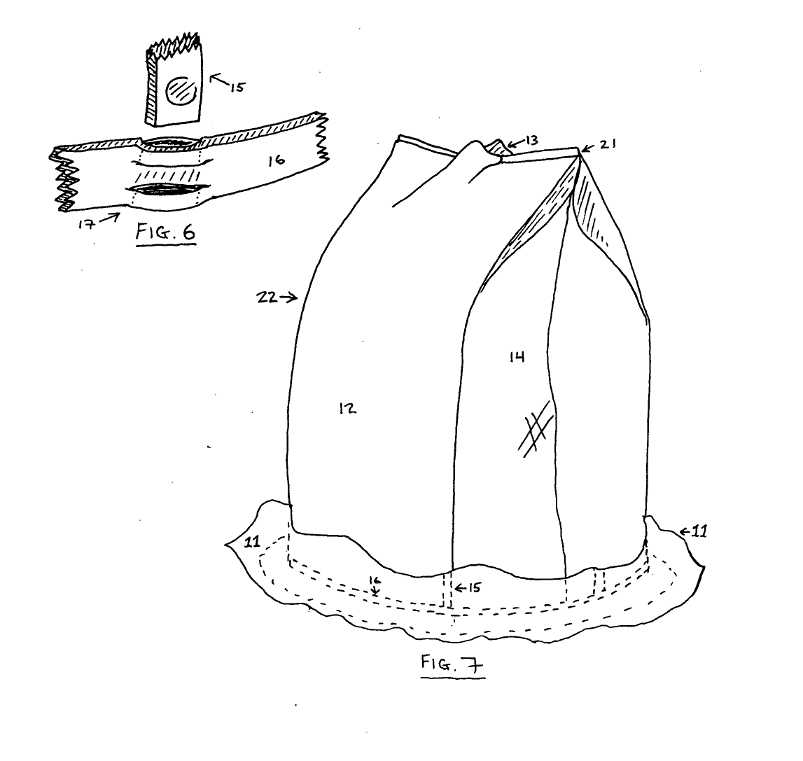

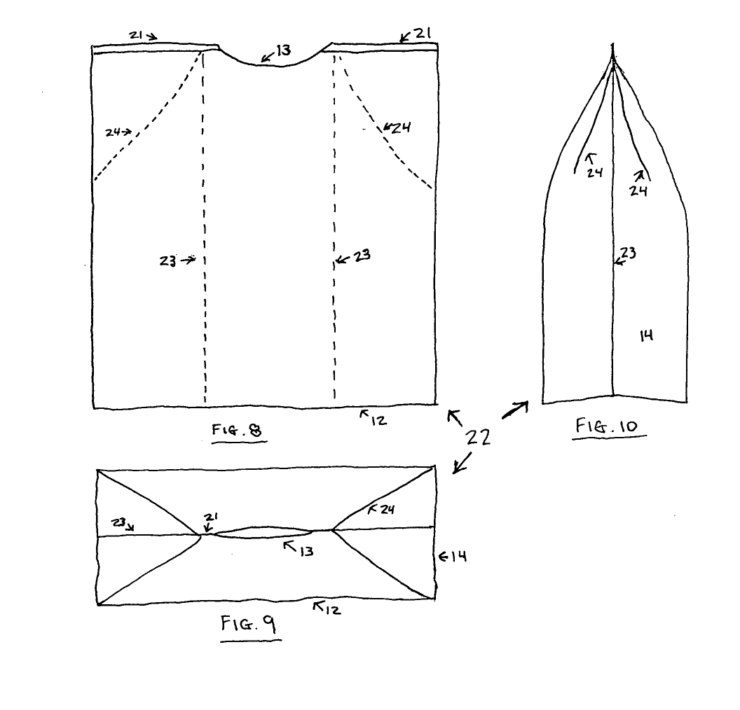

According to various embodiments, the present teachings provide a framework comprising plural (e.g., at least three) collapsible and sprung yet rigid ribs (FIG. 2) joined together and attached to a collapsible and sprung interlocking base ring (FIG. 2) and then enclosed by a fitted and vented polyethylene cover (FIG. 1), said ribs may be joined to one another through a central interlocking point by a flexible cotter pin (FIG. 4), said cotter pin may be inserted and bent to lock in place together as a fixed unit said ribs after passing through the central interlocking point, said ribs then being spread and fanned outward from the central interlocking point to separate at acute (e.g., sixty degree) angles apart from one another, said ribs then being inserted and thus attached to a rigid and collapsible and sprung interlocking circular base ring through means of plural (e.g., six) cut and embossed and or cut and impressed slots that are separate and at acute (e.g., sixty degree) angles from one another on aforementioned base ring, said ribs locking into the aforementioned base ring slots by means of pressed and or embossed dimples at rib ends, said base ring interlocking ends now to be joined together to lock and complete the assembly of the rigid frame, the now complete and assembled and rigid frame then being covered by means of a fitted polyethelene cover (FIG. 1), said cover being opaque on two of the opposing four sides and transparent on two of the opposing four sides, said opaque sides being opposite to one another and said transparent sides being opposite to one another as demonstrated in the figure drawings, said cover being arranged in this pattern so that the opaque north and south facing sides may block the overhead noonday sun thereby protecting the plants contained therein from the highest heat of midday sun and may then also admit sunlight along the east and west facing transparent sides to maximize the warming effects of the morning eastern sun and afternoon western sun so that said cover may regulate the internal temperature by these passive means, said cover being vented at its center point and apex by means of a flexible and integral to the cover vent flap, said vent flap may thereby remain open or may be closed by folding over and clipped shut or being taped, said cover being oversized in terms of its extended bottom length in that it extends sufficiently below the collapsible and sprung and rigid circular base ring so that the extended lower portion of the cover may be covered by loose rocks or soil so that it may weight and anchor it against the effects of wind and precipitation and the elements.

Ventilation can be provided through the vent in the center top of the fitted polyethylene cover, which can be closed through the use, for example, of a clip or tape and can thus contain both water vapor and or humidity and can help trap the heat of the sun-heated soil throughout the hours of darkness and can release heat and water vapor or humidity during the hours of daylight by said vent being left open.

The drying effects of wind may be mitigated by the fitted polyethylene cover, which also may allow gases such as carbon dioxide and oxygen to pass freely through to the outside atmosphere, while it may also allow water vapor to condense on its inner surfaces, which may provide both elevated conditions of humidity to the plant or plants inside the plant protective cover system with collapsible rigid frame during the day and may allow the return of the vaporous water condensate which may collect during the day on the inner wall of the fitted polyethylene cover and may trickle through the process of capillary action down and back to the soil at night along the fitted polyethylene cover sides.

In some embodiments, the fitted polyethylene cover material may have ultraviolet stabilizers added to it. Varying the type and concentration of UV stabilizers in the fitted polyethylene cover material may, for example, provide the fitted polyethylene cover material with varying durability (varieties of which are known in the trade as UV 327 and UV2002). The fitted polyethylene cover material may also comprise other additives that act as antioxidants.

In some embodiments, the plant protective cover system with collapsible rigid frame may also be provided in the form of a collapsible kit, comprising the sprung yet rigid ribs, the flexible cotter pin, the circular interlocking base ring and the fitted polyethylene cover.

According to various embodiments, the plant protective cover system with collapsible rigid frame may then be disassembled at the convenience by the user or maker of the aforementioned plant protective cover system with collapsible rigid frame.

While various embodiments of the present teachings have been described, it should be recognized that various changes, adaptations, and modifications can be made therein without departing from the spirit and scope of the present teachings; e.g., in regards to one or more of the means of affixing or attaching the collapsible rigid ribs to the circular interlocking base ring, and the means of interlocking the circular interlocking base ring ends, as well as in regards to various permutations of the color and shading and reflective area of the fitted polyethylene cover and the composition of the materials of said cover.

It is claimed:

1. An apparatus comprising:
plural (e.g., at least three) collapsible and sprung yet rigid ribs joined together and
attached to a collapsible and sprung yet rigid interlocking base ring to form a
rigid circular paraboloid-shaped frame, then enclosed by a fitted and vented polyethylene cover.
